(19) United States
(12) Patent Application Publication
(10) Pub. No.: US 2007/0022301 A1
(43) Pub. Date: Jan. 25, 2007

(54) System and method for highly reliable multi-factor authentication

(75) Inventors: J. Joseph Nicholson, New York, NY (US); Paul Murphy, Fort Lauderdale, FL (US); Ivo Rothschild, Westmount (CA)

Correspondence Address: Paul D. Greeley;Ohlandt, Greeley, Ruggiero & Perle, L.L.P., 10th Floor, One Landmark Square, Stamford, CT, 06901-2682, US

(73) Assignee: Intelligent Voice Research, LLC

(21) Appl. No.: 11/486,880

(22) Filed: Jul. 14, 2006

Related U.S. Application Data
(60) Provisional application No. 60/700,506, filed on Jul. 19, 2005.

(51) Int. Cl. H04K 1/00

(52) U.S. Cl. 713/184

(57) ABSTRACT

A system and method for authenticating an online user by using different and independent communication services to enhance security. A key server validates the factors of authentication, namely a first factor (username/password) and a second factor (key). The key server generates and sends the key to the user with a different and independent communication service, e.g., telephone, SMS or email. The user then submits the key using the online communication service. A third factor, e.g., a second password or a biometric symbol of the user, can also be used. Validation of the biometric symbol can be a prerequisite to delivery of the key to the user. A plurality of the independent services can be daisy-chained.

### RELATED APPLICATION

This application claims the benefit of U.S. Provisional Patent Application, Ser. No. 60/700,506, filed Jul. 19, 2005, the entire contents of which are hereby incorporated by reference.

### FIELD OF THE INVENTION

The present disclosure generally relates to multi-factor authentication of an on-line user and, in particular, to a system and method that employs two or more different and independent communication services.

### BACKGROUND OF THE INVENTION

Multi-factor authentication is used to ensure that a person accessing a computer system is the person they claim to be by presenting multiple credentials of different types. Single-factor authentication requires the presentation of a datum known by the individual (e.g., a password, a user name or both). Two-factor authentication requires the additional presentation of something the user possesses (e.g., a key generated by a device).

For the sake of the present description, the term “fob” will mean any physical device capable of generating a one-time, expiring key. The fob could be a classic key-chain, a card or software designed to execute on a particular mobile phone, etc. Two-factor authentication with fob-based keys for the second factor was initially used by only very secure computing facilities. Today it is used to protect many corporate networks against phishing, identity theft and other intrusive activities. In classic two-factor authentication, the first factor is something the user knows, e.g., a password or pass phrase. The second factor is something the user has, the fob-based key that generates and displays information synchronized with a central server, usually an alpha-numeric key that changes periodically. An IP provider has recently adopted two-factor authentication that gives users the option of using fobs to protect their accounts.

As the price of implementing multi-factor authentication decreases, it will be adopted by more and more of the institutions with which we interact on a daily basis. How long will it be before the average professional has to carry around a dozen fobs?

There is a need for authentication with high level security.

There is also a need to eliminate the use of fobs used to provide the second authentication factor.

### SUMMARY OF THE INVENTION

A system of the present disclosure authenticates a user with a computer that receives a first factor and a third factor that are sent by the user using a first communication service and a second communication service, respectively. The computer comprises a program that generates a second factor, validates the first and third factors, then causes the second factor to be sent to the user using the second communication service and after receipt of the second factor sent by the user using the first communication service authenticates the user by validating the second factor.

In one embodiment of the system of the present disclosure, the first and third factors are different from one another.

In another embodiment of the system of the present disclosure, the first and third factors are selected from the group consisting of: password, pass phrase, username and any combination thereof.

In another embodiment of the system of the present disclosure, the third factor is a biometric symbol of the user. Preferably, the biometric symbol is selected from the group consisting of: a voiceprint, an iris scan, a fingerprint, a photograph or other symbol of a physical part of the user.

In another embodiment of the system of the present disclosure, the first communication service is an online service.

In another embodiment of the system of the present disclosure, the second communication service is selected from the group consisting of: SMS, telephone (land line or cellular) and page.

In another embodiment of the system of the present disclosure, the second factor comprises one or more series of alphabetic characters, numeric characters or both.

In another embodiment of the system of the present disclosure, the program validates the first and third factors by comparison with a repository of personal data of the user.

The method of the present disclosure authenticates a user by using a computer to perform the steps of:

receiving a first factor and a third factor that are sent by the user using a first communication service and a second communication service, respectively;

generating a second factor;

validating the first and third factors;

then causing the second factor to be sent to the user using the second communication service; and

after receipt of the second factor sent by the user using the first communication service, authenticating the user by validating the second factor.

In one embodiment of the method of the present disclosure the first and third factors are different from one another.

In another embodiment of the method of the present disclosure, the first and third factors are selected from the group consisting of: password, pass phrase, username and any combination thereof.

In another embodiment of the method of the present disclosure, the third factor is a biometric symbol of the user. Preferably, the biometric symbol is selected from the group consisting of: a voiceprint, an iris scan, a fingerprint, a photograph and other symbol of a physical part of the user.

In another embodiment of the method of the present disclosure, the first communication service is an online service.

In another embodiment of the method of the present disclosure, the second communication service is selected from the group consisting of: SMS, telephone (land line or cellular) and page.

In another embodiment of the method of the present disclosure, the second factor comprises one or more series of alphabetic characters, numeric characters or both.

In another embodiment of the method of the present disclosure, the program validates the first and third factors by comparison with a repository of personal data of the user.

In another embodiment of the system of the present disclosure, a computer validates a user of an online service using a first factor and a second factor. The computer sends the second factor to the user using an order of communication services other than the online service for delivery of the second factor to the user. If there is a failure of delivery in a first communication service used in the order, the computer sends the second factor to the user using one of the communication services that is second in the order.

In another embodiment of the system of the present disclosure, the first and second communication services are different than and independent of one another and the online service.

In another embodiment of the system of the present disclosure, the computer automatically uses the second communication service without any input from the user.

In another embodiment of the system of the present disclosure, the communication service is a member of the group consisting of: SMS, email and telephone.

In another embodiment of the system of the present disclosure, the computer authenticates the user using the first factor, the second factor and a third factor. The first factor is a first password and/or username, the second factor is a key and the third factor is a second password.

In another embodiment of the method of the present disclosure, a user of an online service is authenticated by using a computer to perform steps comprising:

validating the user using a first factor and a second factor,

sending the second factor to the user using an order of communication services other than the online service for delivery of the second factor to the user; and

if there is a failure of delivery in a first communication service used in the order, sending the key to the user using one of the communication services that is second in the order.

In another embodiment of the method of the present disclosure, the first and second communication services are different than and independent of one another and the online service.

In another embodiment of the method of the present disclosure, the second communication service automatically sends the second factor without any input from the user.

In another embodiment of the method of the present disclosure, the communication service is a member of the group consisting of: SMS, email and telephone.

In another embodiment of the method of the present disclosure, the user is further validated using a third factor. The first factor is a first password and/or username. The second factor is a key and the third factor is a second password.

### BRIEF DESCRIPTION OF THE DRAWINGS

Other and further objects, advantages and features of the present disclosure will be understood by reference to the following specification in conjunction with the accompanying drawings, in which like reference characters denote like elements of structure and:

FIG. 1 is a schematic representation of a two-factor authentication with two or more communication services according to the present disclosure;

FIG. 2 is a schematic representation of chained key delivery in the face of delivery failure of the system of FIG. 1; and

FIG. 3 is a schematic representation of a three-factor authentication using two or more communication services according to the present disclosure.

### DESCRIPTION OF THE PREFERRED EMBODIMENT

The system and method of the present disclosure provides multi-factor authentication to ensure that a person accessing a computer system is the person they claim to be by presenting multiple credentials of different types. Single-factor authentication requires the presentation of a datum known by the individual (e.g., a password, a user name or both). Two-factor authentication requires the additional presentation of something the user possesses (e.g., a key generated by a device). Three-factor authentication, in one embodiment, requires the user to present some physical part of themselves (e.g., a voiceprint, an iris scan, a fingerprint, a photograph or other biometric symbol).

The system and method of the present disclosure provides authentication with security for an online transaction in which a user enters a username and password using an online service. The security is enhanced by using two or more communication services the user already has available, e.g., an email account, an SMS account or a telephone to deliver a key to the user. This key comprises a computer recognizable expression, e.g., one or more series of alphanumeric characters. This key has an expiration date. This key is the second factor is sent to one of the user's devices. This key eliminates the fob.

In some embodiments, a third factor is also used to identify the user. For example, a voiceprint can be required before a key is delivered over the telephone. In the absence of voiceprint software, a challenge-response dialogue can be used. Another approach is also supported with the introduction of a fingerprint reader or iris scanner. These devices require additional support for the system on the user's device.

In some embodiments, the system and method of the present disclosure monitors the delivery of keys. In case of failure of delivery (e.g., because of an unreliable SMS network), another key delivery service associated with the user is used. These communication services have a predetermined order of delivery. If, for example, the first device in the chain or order is an SMS service, the system waits a defined period of time for delivery to the user to be confirmed. If this confirmation is not received, the key may be automatically sent to the same telephone, via a standard voice call.

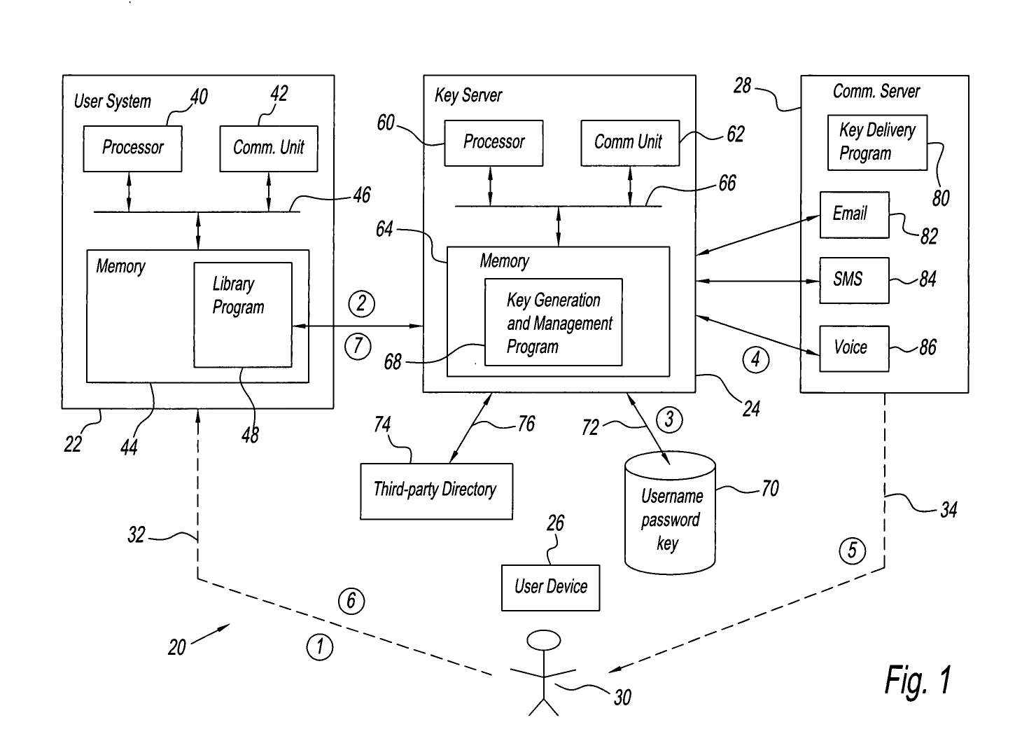

Referring to FIG. 1, an authentication system 20 of the present disclosure comprises a facility computer 22 (e.g., a web site), a key server 24, a communication server 28 and a user device 26 (e.g., a computer, a telephone, a pager). A user 30 uses user device 26 (e.g., a computer) to communicate with facility computer 22 via a first communication service 32 (e.g., IP network). Communication server 28 uses one of its sub-systems (82, 84, 86, etc.) to deliver a key to user device 26.

First communication service 32 may be a typical online dialog between user 30 and facility computer 22 using a web page with prompts for user 30 to enter information. Second communication service 34 can be any one of a plurality of services that are different and independent of one another and of first communication service 32. For example, second communication service 34 may be email, SMS, telephone (land line or cellular), page or other service. All of these services can be offered over a multiple user network, such as an Internet, an Intranet or other network. Alternatively, the telephone service may be offered over the telephone and/or cellular network.

Facility computer 22, e.g., has possession of information concerning user 30, which is to be protected from access by unauthorized persons or entities. For example, facility computer 22 may be used in the conduct of a service business with which user 30 has an account. The provided service might be financial, utility, travel, maintenance or repair or any service that needs to protect private information of user 30.

User 30 can access a user account with the facility by using user device 26 and first communication service 32 to communicate with facility computer 22. Both user device 26 and facility computer 22 are provided with a communication module (not shown) for the purpose of using first communication service 32.

Facility computer 22 comprises a processor 40, a communication module 42 and a memory 44 that are interconnected with a bus 46. Facility computer 22 also comprises an input/output unit (not shown) to communicate with various input/output devices, such as a keyboard, display, a printer and other input/output devices. Facility computer 22 may comprise one or more computers or servers to perform the authentication role of the facility.

A library program 48 is stored in memory 44. Library program 48 is used by application developers to request the generation and authentication of keys. Library program 48 allows facility application developers to integrate the authentication method of the present disclosure into the software of facility computer 22. Library program 48 includes a function to request a key and a function to request the checking of the validity of a key entered by the user. Both functions require valid username and password tokens.

Key server 24 comprises a processor 40, a communication module 42 and a memory 44 that are interconnected with a bus 46. Key server 24 also comprises an input/output unit (not shown) to communicate with various input/output devices, such as a keyboard, display, a printer and other input/output devices. Key server 24 may comprise one or more computers or servers to perform its role in the authentication method of the present disclosure.

A key generation and management program 68 uses a database 70 of user profile information that includes usernames and passwords. The usernames and passwords can be managed internally or externally by a separate server 74, e.g., a Microsoft Active Directory server. If managed internally, key server 24 accesses the user authentication data via a communication link 72. If server 24 and database 70 are located near one another, communication link 72 may simply be a wired link or a short-range wireless link. In other embodiments, communication link 72 could be the Internet or an Intranet. In still other embodiments, the user profile can be stored in memory 64 of key server 24.

If managed externally, key generation and management program 68 can access that data in server 74 using plug-in authentication bridges (not shown) via a communication link 76, which may be the Internet or an Intranet.

Key generation and management program 68 generates random keys. By default, the system uses a series of randomly generated numbers to create a key. The system allows the use of third party key generation software.

Communication server 28 comprises a key delivery program 80 that manages the delivery of keys provided by key server 24 to user 30 via second communication service 34. Communication server 28 can deliver keys via email, SMS or by automated voice application. To this end, a plug-in email communication bridge program 82 is instantiated to deliver keys via email. A plug-in SMS communication bridge program 84 is instantiated to deliver keys via SMS message. An automated voice bridge program 86 is instantiated to deliver keys via a telephone voice message.

In one embodiment of the present disclosure, system 20 performs the following procedure in which the numbered procedural steps correspond to the encircled numbers in FIG. 1:
1. User 30 uses user device 26 and first communication service 32 to enter and send a username and a password to facility computer 22.
2. Library program 48 receives the username and password and requests key server 24 to send a key to user 30.
3. Key generation and management program 68 validates the username and password using the user profile information.
4. If validated, key generation and management program 68 generates the key, stores it in the user profile and hands the key to communication server 28.
5. Communication server 28 uses a predetermined one of communication bridges 82, 84 or 86 and second communication service 34 to deliver the key to user 30.
6. User 30 receives and uses user device 26 and first communication service 32 to enter and send the key to key server 24.
7. Key generation and management program 68 authenticates user 30, using the username, password and key.

In the above example, the key (password or phrase) is delivered to the user using a second communication service (email, SMS or telephone) to which user 30 already subscribes. This is implemented by allowing user 30 of the service (email, SMS or telephone) to return the key by using user device 26 and communication service 32 to system 20. The key is processed by key generation and management program 68 and authenticated in the same way that the first factor (password) is authenticated. The use of second communication service 34 makes the overall process far more secure than a classic two-factor authentication system using only first communication service 32. In this embodiment, key generation and management program 68 comprises code for steps 3, 4 and 7 and key delivery program 80 comprises code for step 5.

Library program 48, key generation and management program 68, key delivery program 80, email bridge communication program 82, SMS bridge communication program 84 and voice bridge program 86 can be written in any suitable language. In one embodiment of key server 24, key generation and management program 68 is written in Java and library program 48 is written in Java and PHP.

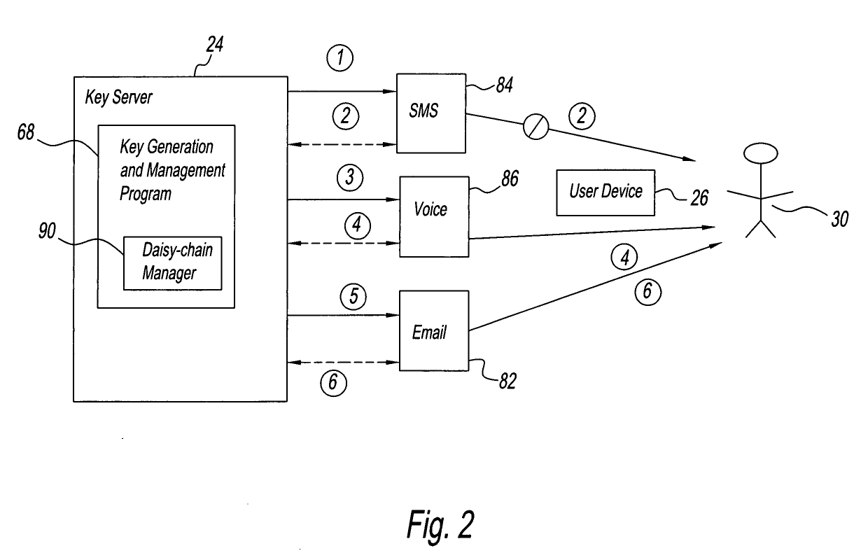

Referring to FIG. 2, key generation and management program 68 comprises a daisy-chain manager 90. Daisy chain manager 90 enables for the purpose of contacting user 30 a predetermined ordering of SMS, voice and email. For example, should the ordering be SMS, telephone and email, user 30 would first be contacted by SMS. Should the SMS contact fail, user 30 would then automatically be contacted by telephone. Should the telephone contact fail, user 30 would then automatically be contacted by email.

Daisy-chain manager 90 has a first activity that gathers a preferred order of contact from user 30. The user's preferred order of contact can be obtained either by online, email, voice or SMS communication service. The preferred order, once gathered is entered into user profile 70.

Daisy-chain manager 90 has a second activity to effect delivery of the key without any input from user 30 in the following manner. When a new key has been generated for user 30, daisy chain manager 90 uses the preferred order to send the key to user 30. Using the above preferred order example, daisy chain manager 90 first instructs key delivery program 80 to select SMS bridge communication program 84 to send the key using SMS service. Second, daisy-chain manager 90 monitors delivery of the key. Third, should delivery fail daisy-chain manager 90 instructs key delivery program 80 to select voice bridge program 86 to send the key using telephone service. Fourth, daisy-chain manager 90 monitors delivery of the key. Fifth, should delivery fail daisy-chain manager 90 instructs key delivery program 80 to select email bridge program 82 to send the key using email service. Sixth, daisy-chain manager 90 monitors delivery of the key. If the delivery fails, daisy-chain manager 90 generates an error message. If any delivery succeeds, the delivery activity ends.

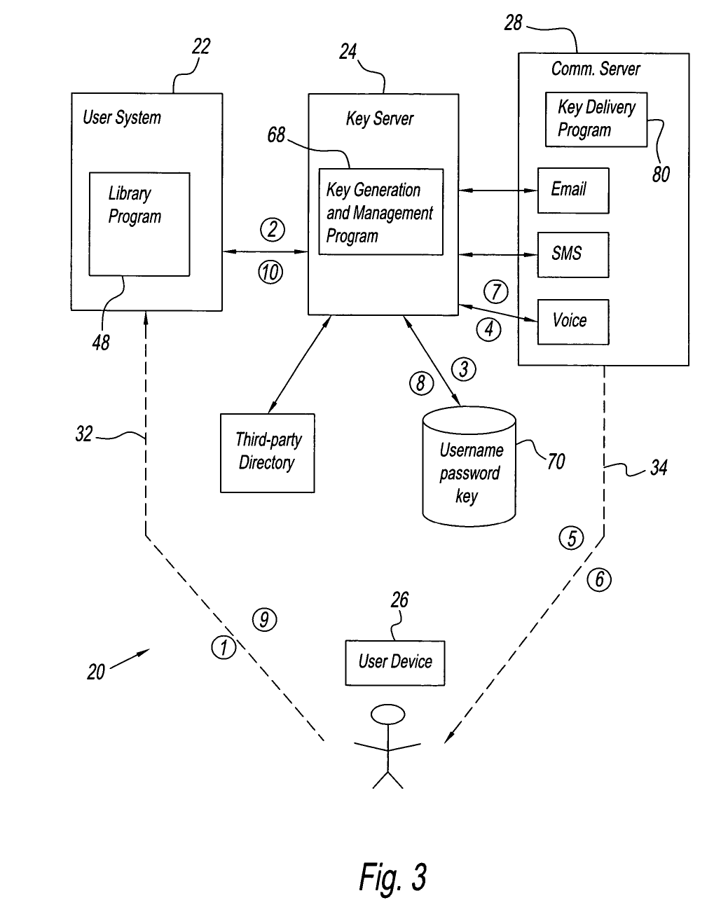

Referring to FIG. 3, in another embodiment of the present disclosure, system 20 performs the following procedure in which the numbered procedural steps correspond to the encircled numbers in FIG. 3:
1. User 30 uses user device 26 and first communication service 32 to enter and send a username and a password to facility computer 22.
2. Library program 48 receives the username and password and requests key server 24 to send a key to user 30.
3. Key generation and management program 68 validates the username and password using the user profile information.
4. If validated, key generation and management program 68 generates the key, stores it in the user profile and hands the key to communication server 28.
5. Communication server 28 uses a predetermined one of communication bridges 82, 84 or 86 and second communication service 34 to deliver the key to user 30.
6. User 30 enters a second password [or biometric token] using user device 26 and second communication service 34.
7. Communication server 28 receives and delivers the second password to key server 24.
8. Key generation and management program 68 stores the second pass word in user profile 70.
9. User 30 enters key using user device 26 and first communication service 32.
10. Facility computer 22 sends the key to key server 24 and key generation and management program 68 authenticates user 30 using username, first password, second password and key.

In the above embodiment, user 30 enters a username and first password into system 20. Library program 48 requests that a key be sent to the user 30. Key server 24 validates the username and first password using user profile 70 or external authentication source 74. If valid to date, key server 24 generates the key, stores it in user profile (with expiry time), and hands it to communication server 28 with the identity of the appropriate communication bridge (defined in user profile). Communication server 28 using the second communication service 34 then notifies user 30 that a key is ready and requests a second password. User 30 enters the second password (or biometric token) using user device 26 and second communication service 34. Communication server 28 delivers the second password to key server 24. Key server 24 validates that token before instructing communication server 28 to send the key using communication service 34. User 30 uses user device 26 and communication service 32 to enter the key into system 22. Facility server 22 sends the key to key server 24. Key server 24 further authenticates user 30 using the key. In this embodiment, key generation and management program 68 comprises code for steps 3, 4, 8 and 10. Key delivery program 80 comprises code for steps 5 and 7. Library program 48 comprises code for steps 2 and 9.

The second password can be any word, phrase, biometric token, or any combination thereof. In one preferred embodiment, the second password is a biometric symbol of user 30. The biometric symbol, for example may be a voiceprint, an iris scan, a fingerprint, a photograph or other biometric symbol of user 30.

The present disclosure defines the components required for the process to operate within set norms of security, but does not place any limitations on implementation. The norms defined are: (a) two-factor, with the key from the second factor (the virtual fob) being sent over the same service as the password; (b) two-factor, over two services, with a second key (something the user knows) being sent over the second service; and (c) three-factor over two services; and (d) device chaining in order to ensure delivery of requested keys.

The present disclosure having been thus described with particular reference to the preferred forms thereof, it will be obvious that various changes and modifications may be made therein without departing from the spirit and scope of the present disclosure as defined in the appended claims.

What is claimed is:

1. A system that authenticates a user comprising a computer that receives a first factor and a third factor that are sent by said user using a first communication service and a second communication service, respectively, wherein said computer comprises a program that (a) generates a second factor, (b) validates said first and third factors, (c) then causes said second factor to be sent to said user using said second communication service and (d) after receipt of said second factor sent by said user, using said first communication service authenticates said user by validating said second factor.

2. The system of claim 1, wherein said first and third factors are different from one another.

3. The system of claim 2, wherein said first and third factors are selected from the group consisting of: password, pass phrase, username and any combination thereof.

4. The system of claim 2, wherein said third factor is a biometric symbol of said user.

5. The system of claim 4, wherein said biometric symbol is selected from the group consisting of: a voiceprint, an iris scan, a fingerprint, a photograph or other symbol of a physical part of said user.

6. The system of claim 1, wherein said first communication service is an online service.

7. The system of claim 1, wherein said second communication service is selected from the group consisting of: SMS, email, telephone and page.

8. The system of claim 1, wherein said second factor comprises one or more series of alphabetic characters, numeric characters or both.

9. The system of claim 1, wherein said program validates said first and third factors by comparison with a repository of personal data of said user.

10. A method that authenticates a user comprising:
using a computer to perform the steps of:
receiving a first factor and a third factor that are sent by said user using a first communication service and a second communication service, respectively;
generating a second factor;
validating said first and third factors;
then causing said second factor to be sent to said user using said second communication service; and
after receipt of said second factor sent by said user using said first communication service, authenticating said user by validating said second factor.

11. The method of claim 10, wherein said first and third factors are different from one another.

12. The method of claim 11, wherein said first and third factors are selected from the group consisting of: password, pass phrase, username and any combination thereof.

13. The method of claim 11, wherein said third factor is a biometric symbol of said user.

14. The method of claim 13, wherein said biometric symbol is selected from the group consisting of: a voiceprint, an iris scan, a fingerprint, a photograph and other symbol of a physical part of said user.

15. The method of claim 10, wherein said first communication service is an online service.

16. The method of claim 10, wherein said second communication service is selected from the group consisting of: SMS, email, telephone and page.

17. The method of claim 10, wherein said second factor comprises one or more series of alphabetic characters, numeric characters or both.

18. The method of claim 10, wherein said program validates said first and third factors by comparison with a repository of personal data of said user.

19. A system comprising a computer that validates a user of an online service using a first factor and a second factor, wherein said computer sends said second factor to said user using an order of communication services other than said online service for delivery of said second factor to said user, wherein if there is a failure of delivery in a first communication service used in said order, said computer sends said second factor to said user using one of said communication services that is second in said order.

20. The system of claim 19, wherein said first and second communication services are different than and independent of one another and said online service.

21. The system of claim 19, wherein said computer automatically uses said second communication service without any input from said user.

22. The system of claim 19, wherein said communication service is a member of the group consisting of: SMS, email, telephone and page.

23. The system of claim 19, wherein said computer authenticates said user using said first factor, said second factor and a third factor, wherein said first factor is a first password and/or username, wherein said second factor is a key and wherein said third factor is a second password.

24. A method of authenticating a user of an online service by using a computer to perform steps comprising:
validating said user using a first factor and a second factor,
sending said second factor to said user using an order of communication services other than said online service for delivery of said second factor to said user; and
if there is a failure of delivery in a first communication service used in said order, sending said key to said user using one of said communication services that is second in said order.

25. The method of claim 24, wherein said first and second communication services are different than and independent of one another and said online service.

26. The method of claim 24, wherein said second communication service automatically sends said second factor without any input from said user.

27. The method of claim 24, wherein said communication service is a member of the group consisting of: SMS, email, telephone and page.

28. The method of claim 24, wherein said user is further validated using a third factor, wherein said first factor is a first password and/or username, wherein said second factor is a key and wherein said third factor is a second password.
